(19) United States
(12) Patent Application Publication
(10) Pub. No.: US 2017/0082224 A1
(43) Pub. Date: Mar. 23, 2017

(54) Fuel Dispenser Blending Hose

(71) Applicant: Wayne Fueling Systems LLC, Austin, TX (US)

(72) Inventors: Bengt I. Larsson, Skivarp (SE); Mattias G. Martensson, Kavlinge (SE); Mo Afshar, Austin, TX (US); James Sanders, Austin, TX (US); Scott R. Negley, Austin, TX (US)

(21) Appl. No.: 15/272,029

(22) Filed: Sep. 21, 2016

Related U.S. Application Data
(60) Provisional application No. 62/221,402, filed on Sep. 21, 2015.

(51) Int. Cl. F16L 11/22; B67D 7/74; B67D 7/38; B67D 7/62

(52) U.S. Cl. CPC F16L 11/22; B67D 7/62; B67D 7/74; B67D 7/38

(57) ABSTRACT

Fuel hoses are provided herein to deliver a blend of fuels. For example, a fuel hose is provided that includes an upper hose portion with a first channel for delivering a first fuel and a second channel for delivering a second fuel. A lower hose portion with a third channel extending therethrough couples to a nozzle. The lower hose can couple to the upper hose portion at a joint that receives the first and second fuels. The first and second fuels can mix at the joint to form a blended fuel that is delivered through the lower hose portion to the nozzle.

### FIELD

Methods and devices are provided for delivering a mixture of fluids, including fuels and additives.

### BACKGROUND

Current fuel dispensers are configured to deliver multiple grades of fuel, either through a single hose or through separate hoses. In the U.S., different fuel grades and/or additives can be blended within the dispenser to form a blended mixture that is delivered to the hose for delivery from the nozzle to a vehicle. Blending currently occurs in the dispenser prior to delivery to the hose. This is necessary as the hose must have a certain diameter in order to provide a sufficient flow rate, while also remaining fairly flexible and light weight to facilitate maneuverability by a user. One problem with such a configuration, however, is that the blended mixture remaining in the hose (referred to as the residual fluid) is dispensed to a subsequent user. For example, a lower grade of fuel can remain in the hose and is delivered to a user attempted to obtain a higher grade of fuel. Similarly, an additive can remain in the hose while a user attempts to obtain a fuel with a different additive or with no additive.

Contamination by the residual fluid is considered acceptable in the U.S. in which larger volumes of fluid tend to be delivered, thus diluting the amount of contamination. Other markets outside of the U.S., however, have more strict requirements and further limit the amount of residual fluid that can be delivered to a subsequent user. In certain markets, users only dispense a small volume of fuel, and thus the residual volume can cause a more significant contamination. Accordingly, in some markets blending is eliminated, and the gas station is required to have separate tanks and separate hoses for each fuel grade. The requirement for multiple hoses can be undesirable, as the dispensers tend to be very large and bulky.

Accordingly, there remains a need for methods and devices for delivering a mixture of fluids, and in particular for blending fuel grades or fuels and additives and delivering the blended fluid through a single hose.

### SUMMARY

Various methods and devices are provided for blending fluids in a fuel dispenser.

In one aspect, a fuel hose for blending and delivering multiple fuels is provided. The fuel hose has an upper hose portion with first and second elongate hollow structures extending therethrough adjacent to one another. The first elongate hollow structure has a first end configured to receive a first fuel and a second end. The second elongate hollow structure has a first end configured to receive a second fuel and a second end. The fuel hose also includes a lower hose portion with a third elongate hollow structure with a first end that is coupled to both the second end of the first elongate hollow structure and the second end of the second elongate hollow structure. The third elongate hollow structure is configured to receive a blended fuel formed from the first and second fuels. The lower hose portion also has a second end that is configured to couple to a nozzle.

The fuel hose can vary in numerous ways. For example, the lower hose portion can have a flexibility that is greater than a flexibility of the upper hose portion. The upper hose portion can also include an outer retainer, such as a sheath or wrap, with the first and second elongate hollow structures disposed therein. The lower hose portion can have a length that is less than a length of the upper hose portion. In another example, a diameter of the upper hose portion can be equal to or greater than a diameter of the lower hose portion. The fuel hose can also include a vapor recovery hose extending through the upper and lower hose portions. In some embodiments, the vapor recovery hose can be sandwiched between the first and second elongate hollow structures in the upper hose portion. The first and second elongate hollow structures each can have a substantially D-shaped cross-section.

In another aspect, a fuel hose for blending and delivering multiple fuels is provided. The fuel hose has an upper hose portion with a first channel extending therethrough for delivering a first fuel and a second channel extending therethrough for delivering a second fuel. The upper hose portion has a first end configured to couple to a fuel dispenser for receiving the first and second fuels and a second end. The fuel hose has a lower hose portion with a third channel extending therethrough and a first end and a second end configured to couple to a nozzle. The fuel hose also has a manifold with a first end coupled to the second end of the upper hose portion for receiving the first and second fuels from the first and second channels in the upper hose portion. The manifold is configured to deliver the first and second fuels to a mixing chamber formed within the manifold. The first and second fuels mix to form a blended fuel, and the manifold has a second end coupled to the first end of the lower hose portion for delivering the blended fuel to the lower hose portion.

The fuel hose can have numerous variations. For example, the manifold can include first and second separate and distinct fuel channels formed in a first portion thereof adjacent to the first end. The channels are for receiving the first and second fuels from the second end of the upper portion. The mixing chamber is formed in a second portion thereof adjacent to the second end for delivering the blended fuel to the lower hose portion. The lower hose portion can have a flexibility that is greater than a flexibility of the upper hose portion. The lower hose portion can also have a length that is less than a length of the upper hose portion. The first and second channels in the upper hose portion can extend adjacent to one another through the upper hose portion. In another example, the second channel can be coaxially disposed within the first channel in the upper hose portion. The fuel hose can also include a vapor recovery hose extending through the upper hose portion, through the manifold, and through the lower hose portion. In some embodiments, the vapor recovery hose can extend through one of the first and second channels in the upper hose portion. In other embodiments, the vapor recovery hose can be sandwiched between the first and second channels in the upper hose portion.

In another aspect, a fuel dispenser is provided that includes a dispenser housing with at least one fuel pumping unit. The fuel dispenser includes a hose with an upper hose portion with a first end coupled to the dispenser housing. The upper hose portion has first and second fuel flow pathways, and the first fuel flow pathway is configured to receive a first fuel from the at least one fuel pumping unit. The second fuel flow pathway is configured to receive a second fuel from the at least one fuel pumping unit. The fuel dispenser has a lower hose portion with a first end in fluid communication with a second end of the upper hose portion. The lower hose portion is configured to receive a blended fuel formed from mixing of the first and second fuels from the first and second fuel flow pathways. The second hose portion has a second end coupled to a nozzle for delivering the blended fuel to a vehicle.

The fuel dispenser can have a variety of different variations. For example, the fuel dispenser can include a coupling connected between the second end of the upper hose portion and the first end of the lower hose portion. The coupling can include a blending chamber that forms the blended fuel by mixing the first and second fuels. In another example, when the nozzle is seated within a nozzle boot on the dispenser housing, the coupling can be positioned at a lower elevation than the upper and lower hose portions. In another embodiment, the lower hose portion can have a length that is less than a length of the upper hose portion. A diameter of the upper hose portion can be equal to or greater than a diameter of the lower hose portion. The fuel hose can also include a vapor recovery hose extending through the upper and lower hose portions.

### BRIEF DESCRIPTION OF DRAWINGS

The embodiments described above will be more fully understood from the following detailed description taken in conjunction with the accompanying drawings. The drawings are not intended to be drawn to scale. For purposes of clarity, not every component may be labeled in every drawing. In the drawings:

FIG. 1 is a perspective view of one embodiment of a fuel dispensing unit having a hose for blending multiple grades of fuel;

FIG. 2 is a side schematic view of a hose and a nozzle according to one embodiment;

FIG. 3 is a perspective view of a hose and a nozzle according to another embodiment;

FIG. 4 is a perspective view of the hose and the nozzle of FIG. 3, showing an outer retainer disposed around a portion of the hose;

FIG. 5 is a cross-sectional view of an upper portion of a hose according to another embodiment;

FIG. 6 is a cross-sectional view of a lower portion of the hose of FIG. 5;

FIG. 7 is a side cutaway view of a portion of a hose according to another embodiment;

FIG. 8 is a cross-sectional view across Line A of FIG. 7;

FIG. 9 is a cross-sectional view across Line B of FIG. 7;

FIG. 10 is a cross-sectional view of an upper portion of a hose according to another embodiment having a vapor recovery tube extending therethrough;

FIG. 11 is a cross-sectional view of a lower portion of the hose of FIG. 10;

FIG. 12A is a side cross-sectional view of a portion of a hose having a coupling for mixing fluid, according to another embodiment;

FIG. 12B is a side cross-sectional view of one component of the coupling of FIG. 12A;

FIG. 12C is a perspective view of the coupling of FIG. 12A with a second component shown disassembled from a first component;

FIG. 12D is a perspective view of the hose of FIG. 12A coupled to a lower hose portion and a nozzle;

FIG. 12E is a side and front perspective view of a portion of the coupling of FIG. 12A;

FIG. 13 is a side cross-sectional view of a portion of a hose having a coupling for mixing fluid, and having a vapor recovery tube, according to another embodiment; and

FIG. 14 is a perspective view of a fuel dispensing unit according to one embodiment.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Various hose configurations are provided for delivering a variety of fuel grades from a fuel dispenser. The hoses are configured to receive multiple fluids, and to form a mixture of fluids, such as a blended grade of fuel or a mixture of a fuel and an additive, for delivery through a nozzle. In an exemplary embodiment, the hose has a joint located there along at which two fluids flowing through two separate pathways in the hose assembly are mixed to form a fluid mixture. For example, two or more grades of fuel can be combined within one hose to produce an intermediate blended grade of fuel for delivery to a vehicle. The amount of each grade of fuel that is delivered can be controlled by the fuel dispensing unit, for example by one or more valves, meters, pumps, etc., to achieve a desired blended grade.

As discussed above, blending in current fuel dispensers occurs within the dispenser, prior to delivering the fluid to the hose. This can disadvantageously result in delivery of a residual amount of blended fluid to a subsequent user. Alternatively, blending can alternatively occur at the nozzle in order to reduce an amount of blended fluid that remains in the hose subsequent to use, thereby preventing a subsequent user from receiving the remaining blended fluid. However, such a configuration can be costly to manufacture and can result in a heavy and bulky nozzle, making user manipulation more difficult. Accordingly, the hoses disclosed herein have a blend point that is located along the hose at a distance away from the nozzle. While such a configuration is more desirable, it also presents new issues. For example, in a hose having an upper portion with multiple fluid channels that flow into a lower portion with a single fluid channel, flow rate can be an issue. A minimum flow rate is desirable to ensure usability of the fuel dispensing units. While flow rate can be increased by increasing a diameter and/or a cross-sectional area of a hose, any increase in diameter will render the hose less flexible and will increase the weight of the hose, making it more difficult to handle and maneuver. Additionally, vapor recovery systems, such as a vapor recovery hose, are often incorporated into hose and nozzle configurations based on local laws and restrictions, further adding to the overall thickness and stiffness of a hose and increasing the difficulty in maneuvering a nozzle attached to the hose. It is thus important to strike a balance between ensuring acceptable flow rate by having a minimum diameter and/or cross-sectional area while ensuring flexibility and movability of the hose. The relative diameters and/or cross-sectional areas of the one or more hoses compared to each other must be optimized, and the minimum and maximum diameters and/or cross-sectional areas of the one or more hoses must be perfected. Without optimizing the flow rate compared to the movability of the hose(s), the usefulness of the hose(s) is greatly decreased. Achieving this balance is important and difficult. Accordingly, the hoses disclosed herein include a flexible section located between the nozzle and the blend joint that facilitate ease of use of the hose, while maintaining an acceptable flow rate.

Furthermore, as indicated above, mixing more than one fuel grade in the dispenser leads to a select amount of residual blended fuel extending through the entire length of the hose. The amount of residual blended fuel is preferably minimized, and there is often a maximum amount of residual blended fuel that can be provided to a new user by law. It is consequently desirable to configure a hose to have a blend point that results in a reduced volume of blended fluid, while still meeting the flexibility requirements that enable handling of the hose. Accordingly, by positioning the blend point a distance apart from the nozzle, the flexible hose section extending from the blend point to the nozzle facilitate maneuverability while at the same time reducing an amount of residual fluid. Because only a portion closest to the nozzle contains the blended fuel, only a small amount of blended fuel will remain within the hose. The unblended fuel located within the remainder of the hose is retained within the hose as a result the pressures within the system.

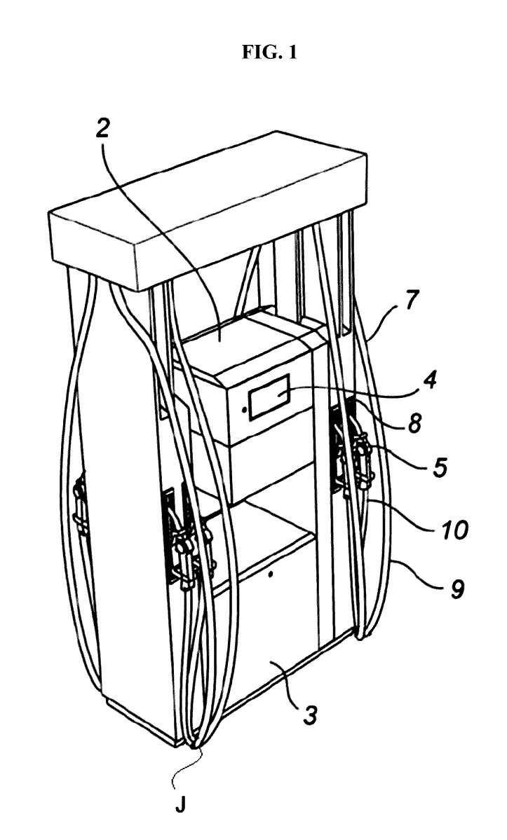

FIG. 1 illustrates one embodiment of a fuel dispensing unit 1 for refueling motor vehicles. The illustrated fuel dispensing unit 1 has an electrical cabinet 2 containing all the electronics for the fuel dispensing unit 1, including a pump display 4 showing pump data. The fuel dispensing unit 1 also includes a hydraulics cabinet 3 containing fuel dispensing means (not shown), e.g. fuel metering means, valves, vapor recovery system etc. The fuel dispensing unit 1 is connected to an underground reservoir (not shown) containing fuel. When filling up the tank of a motor vehicle, the fuel is pumped from the underground reservoir by means of a pump (not shown) which is located in the hydraulic cabinet 3, and from there to a nozzle 5 via a fuel pipe (not shown) and a fuel hose 7. When the fuel hose 7 is not in use, the fuel hose 7 hangs along the fuel dispensing unit 1, and the nozzle 5 is inserted in a nozzle boot 8. FIG. 1 illustrates four hoses and four nozzles on one side of the dispenser, and four hoses and four nozzles on the other side of the dispenser. A person skilled in the art will appreciate that the dispenser can have various other configurations known in the art and can include any number of hoses and nozzles.

The fuel is pumped along a fuel pathway from the underground reservoir and through a series of valves and meters and finally out of the nozzle 5 and into a vehicle using positive pressure. Positive pressure is created in the fuel pathway using the pump. When the fuel dispensing unit 1 dispenses fuel, the fuel can flow through a variety of valves and meters, for example, a check valve, a meter, and a control valve (not necessarily in that order) because of the positive pressure in the fuel pathway. As non-limiting examples, the check valve can act to prevent any backflow of fuel in the fuel pathway to ensure the fuel flows in only one direction, the meter can act to count the amount of fuel being pumped, and the control valve can act to control the flow rate and blend ratio and it can be configured to assist in applying positive pressure to fuel in the fuel hose 7. Thus the fuel dispensing unit 1 can use positive pressure in one or more fuel flow paths from the underground reservoir to the nozzle 5 through use of one or more of a valve, a meter, a pump, etc., and the positive pressure and the one or more valve(s) allow the fuel dispensing unit 1 to pump multiple grades of fuel at once and/or one grade of fuel while preventing another grade of fuel from flowing.

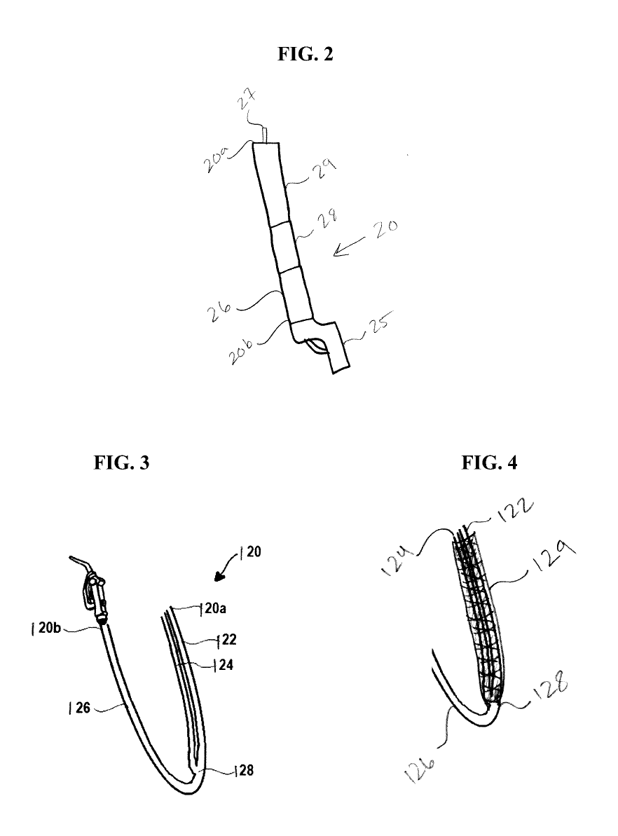

FIG. 2 illustrates an exemplary embodiment of a fuel hose 20 that can be used to deliver multiple fuels, such as multiple grades of fuel or a mixture of a fuel(s) and a fuel additive, through a single nozzle. As shown, the fuel hose 20 has an upper end 20a that is configured to connect to the top of the dispenser for receiving fuel from the fuel dispensing unit 1, and a lower end 20b having a nozzle 25 coupled thereto. An upper portion 29 of the fuel hose 20 includes the upper end 20a and has at least two separate fluid channels for receiving first and second fluids, as well as an optional vapor recovery hose 27. The fluid channels can be formed within the upper portion 29, or they can be formed from two separate hoses that are positioned adjacent to one another and optionally joined together by a retaining member, such as a sheath or wrap, disposed therein. A lower portion 26 of the fuel hose 20 includes the lower end 20b and has a single fluid channel for delivering a blended fuel that is formed from a mixture of the first and second fuels in the upper portion 29. The vapor recovery hose 27 can optionally extend through the upper portion 29 and the lower portion 26. The fluid channels in the upper portion 29 are connected to the fluid channel in the lower portion 26 at a joint 28. The joint 28 can have a variety of forms. For example, in one embodiment the hose can be molded as a single unitary/monolithic hose, and the joint can merely be the junction where the internal configuration changes from a dual lumen to a single lumen configuration (with or without a vapor recovery hose disposed therethrough). Alternatively, the junction can be a separate component, such as a coupling or manifold, that connects the upper and lower portions of the hose and that has a mixing chamber where the fluids from the upper portion are mixed for delivering to the lower portion.

In use, a first fuel (e.g., a first fuel grade) can be delivered through one fluid channel of the upper portion 29 and a second fuel (e.g., an additive or a second fuel grade that differs from the first fuel grade) can be delivered through a second fluid channel of the upper portion 29. The first and second fuels will be combined when they flow through the joint 28, such that the lower portion 26 receives a blended fuel formed from a mixture of the first and second fuels. The blended fuel will then be delivered through the nozzle 25 to a vehicle. A person skilled in the art will appreciate that the fluid channels can have a variety of configurations, and the hose can be used to mix any combination of fluids, including various fuel grades and various additives. The hose is not limited to use in blending two fuel grades. The term “fuel” as used herein is thus intended to encompass various grades of fuels, as well as fuel additives, or other fluids as may be desired.

The location of the joint 28 along the hose 20 can also vary. In order to reduce an amount of residual or blended fuel remaining within the hose after fuel delivery to a vehicle is complete, the joint 28 is preferably located along a mid-portion of the hose 20 or closer to the nozzle 25 than the fuel dispenser. While the particular location of the joint 20 can vary, in an exemplary embodiment the joint 28 is located at the bottom of the drape area, i.e., the portion of the hose that hangs down to the ground, between the bottom of the drape area and the nozzle. For example, the joint 20 can be located at a lower elevation compared to the remainder of the hose when the nozzle is seated in the nozzle boot. The joint is thus at the beginning or close to the beginning of the portion of the fuel hose 20 that is moved around by a user when refueling a vehicle. This portion of the hose 20 should fulfill certain requirements regarding flexibility and mobility, and therefore having the joint 28 at the beginning of this portion allows this portion to maintain the required flexibility. With reference to FIG. 1, the portion of the hose that is moved around by a user begins at the location marked with the letter “J,” i.e. at the bottom of the hose adjacent to the ground. As will be appreciated, a length of the hose extending from the location of the joint 28 (e.g., location J) to the nozzle is relatively short. In an exemplary embodiment, the length of the lower hose portion 26 is equal to or less than the total length of the hose by about ½, and more preferably by at least ⅓. The lower hose portion 26 preferably has a length that is minimized while still allowing the lower portion to flex during positioning of the nozzle. In one exemplary, the hose has a total length of about 3 m, and the length of the lower hose portion 26 is in the range of about 0.5 to 1 m. Due to the relatively small distance between the joint 28 and the nozzle, only a small amount of residual or blended fluid will thus remain in the hose.

The illustrated configuration of the hose is also particularly advantageous as it allows a range of fuel grades to be blended as may be desired. For example, if a first fluid channel of the upper portion 29 is in fluid communication with a first underground reservoir containing fuel having an octane rating of 85, and a second fluid channel of the upper portion 29 is in fluid communication with a second underground reservoir containing fuel having an octane rating of 91, an amount of each fuel can be selectively delivered through the hose 20 to achieve a blended fuel having an octane rating of 86, 87, 88, 89, or 90, as may be desired. Accordingly, the fuel hose 20 enables delivery of a wide range of fuel grades through a single nozzle.

FIG. 3 illustrates another exemplary embodiment of a fuel hose 120 that can be used to deliver multiple fluids, similar to that of FIG. 2. The fuel hose 120 has an upper end 120a that is configured to connect to the fuel dispensing unit 1 for receiving fuel, and a lower end 120b having a nozzle 125 coupled thereto. An upper portion 129 of the fuel hose 120 includes the upper end 120a and has two separate fluid channels in the form of tubular structures 122, 124. The upper portion 129 can include a retainer, such as a sheath, wrap, or cover 129, as shown in FIG. 4, that encloses the two separate tubular structures 122, 124. A lower portion 126 of the fuel hose 120 includes the lower end 120b and has only a single fluid channel therein that is defined by the tubular structure of the lower portion 126. The tubular structures 122, 124 of the upper portion 129 are connected to the tubular structure of the lower portion 126 at a joint 128. A first fuel can be delivered through tubular structure 122 and a second fuel that differs from the first fuel can be delivered through tubular structure 124. The two fuels will be combined when they flow through the joint 128 to form a blended fuel that is delivered into the tubular structure of the lower portion 126. The blended fuel will then be delivered through the nozzle 125 to a vehicle.

In various embodiments, the hose 120 can be formed using a Y-shaped steel pin construct having a shape that matches the desired configuration of the hose. One or more layers of rubber can be formed around the construct and volcanized. Once formed to a desired thickness, the steel pin construct can be extracted from the hose. This can be achieved by using a construct with components that are separable from one another so as to remove separate portions of the pin from each tubular structure 122, 124, 126. While the joint 28 can have a variety of configurations, the joint 128 is configured such that fluid can flow continuously from the tubular structures 122, 124 of the upper portion 129 to the tubular structure of the lower portion 126.

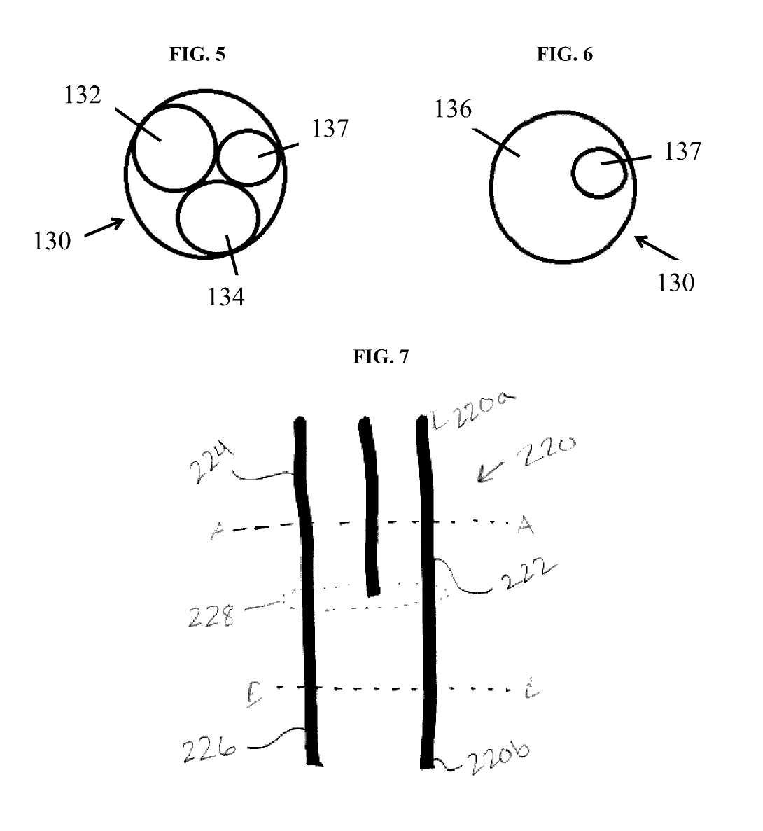

Optionally a vapor recovery system, such as a vapor recovery hose, can be incorporated into the fuel hose. Cross-sections of an exemplary embodiment of a fuel hose 130 having a vapor recovery hose are shown in FIGS. 5 and 6, and are similar to the fuel hose 120. The upper portion of the hose includes two separate upper fuel passageways 132, 134 that are substantially circular in cross-section, as shown in FIG. 5, and the lower portion of the hose includes a lower fuel passageway 136, as shown in FIG. 6. The vapor recovery hose 137 extends through the fuel hose 130 adjacent to the fuel passageways 132, 134 in the upper portion of the hose, and extends through the lower portion. The vapor recovery hose 137 can be positioned at various locations within the hose, e.g., along the central longitudinal axis or offset, or it can float therein as may occur during movement of the fuel hose 130.

In another embodiment as illustrated in FIG. 7, a fuel hose 220 can be used to deliver multiple fluids, similar to the fuel hose 20 of FIG. 2. The fuel hose 220 has an upper end 220a that is configured to connect to the fuel dispensing unit 1 for receiving fuel from the fuel dispensing unit 1, and a second end 220b having a nozzle coupled thereto. An upper portion of the fuel hose 220 includes the first end 220a and has two separate fuel passageways 222, 224. A lower portion of the fuel hose 220 includes the second end 220b and has a single tubular structure 226. The passageways 222, 224 are formed from a single piece of material that is molded to form the entire fuel hose 220. As in the fuel hose 20 above, the fuel passageways 222, 224 of the upper portion are connected to the tubular structure 226 of the lower portion at a joint 228. Because the passageways 222, 224, the joint 228, and the tubular structure 226 are all molded from a single piece of material, there is not a need for a separate coupling or manifold.

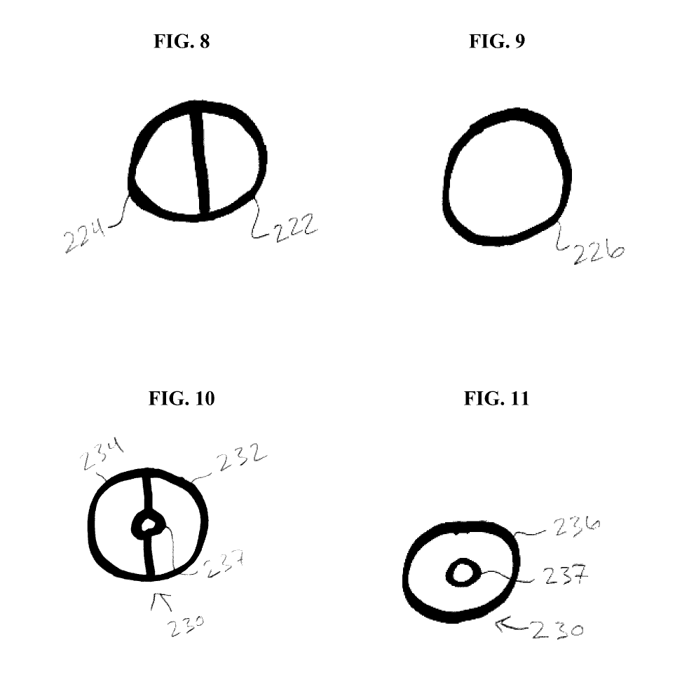

FIG. 8 illustrates an exemplary cross-sectional shape for the fuel passageways 222, 224 in the upper portion. As shown, each passageway has a generally D-shaped cross-section. Thus, each passageway occupies half of the inner area of the upper portion of the hose. FIG. 9 illustrates an exemplary cross-sectional shape for the lower portion of the hose. As shown, the lower portion is circular in shape. A person skilled in the art will appreciate that the cross-sectional shape of each fluid passageway can vary, and the relative cross-sectional areas can also vary.

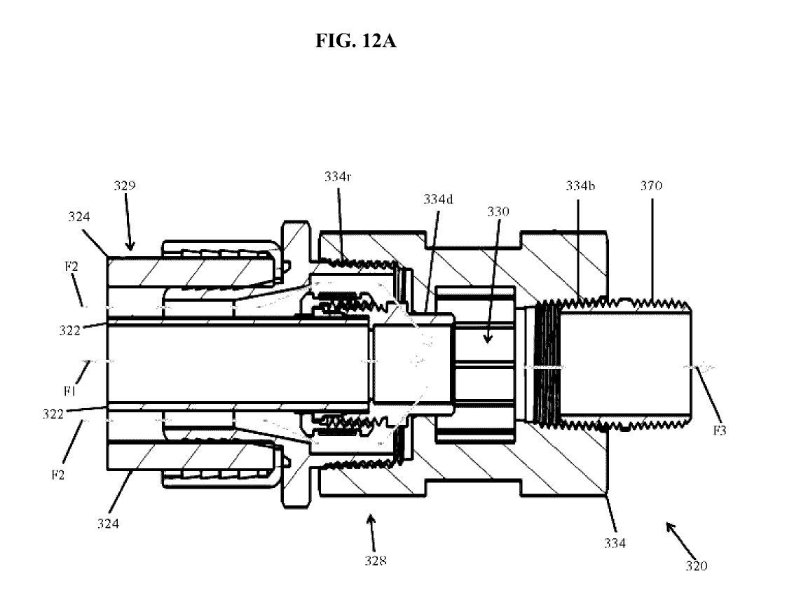

Optionally a vapor recovery system, such as a vapor recovery hose, can be incorporated into the fuel hose as well. Cross-sections of an exemplary embodiment of a fuel hose 230 having a vapor recovery hose, are shown in FIGS. 10 and 11, and are similar to the fuel hose 220. The upper portion of the hose includes two separate upper fuel passageways 232, 234 that are substantially D-shaped in cross-section, as shown in FIG. 10, and the lower portion of the hose includes a lower fuel passageway 236, as shown in FIG. 11. The vapor recovery hose 237 is sandwiched between the fuel passageways in the upper portion of the hose such that the vapor recovery line extends along the central axis of the hose. The vapor recovery hose 237 in the lower portion is likewise positioned along the central axis of the hose, but can float therein as may occur during movement of the hose.

Since fuel hose 220 is manufactured so as to eliminate the need for any connector valve or separate coupling element between the upper and lower portions, smooth fluid flow can be achieved. Further, the addition of extra weight due to the presence of a coupling is eliminated. The fluid flow is maximized by using all available cross-sectional space, and weight and stiffness are minimized because the hose is formed from a single integral, mono-lithic structure.

In use, a first fuel can be delivered through tubular structure 222 and a second fuel that differs from the first fuel can be delivered through tubular structure 224. The two fuels will be combined when they flow through the joint 228 to form a blended fuel which his delivered into tubular structure 226. The blended fuel will then be delivered through a nozzle to a vehicle. A diameter of the fuel hose 220 is constant throughout the hose, and cross-sectional areas of the fuel passageways 222, 224 of the upper portion compared to the tubular structure 226 of the lower portion are approximately equal. There will be a minor amount of area lost to the material placed between the fuel passageways 222, 224. During use, only the blended fuel located within the lower portion will be delivered to a subsequent user, as the pressures within the system will function to maintain the fuels within the upper portion of the hose. Accordingly, the residual amount is significantly reduced.

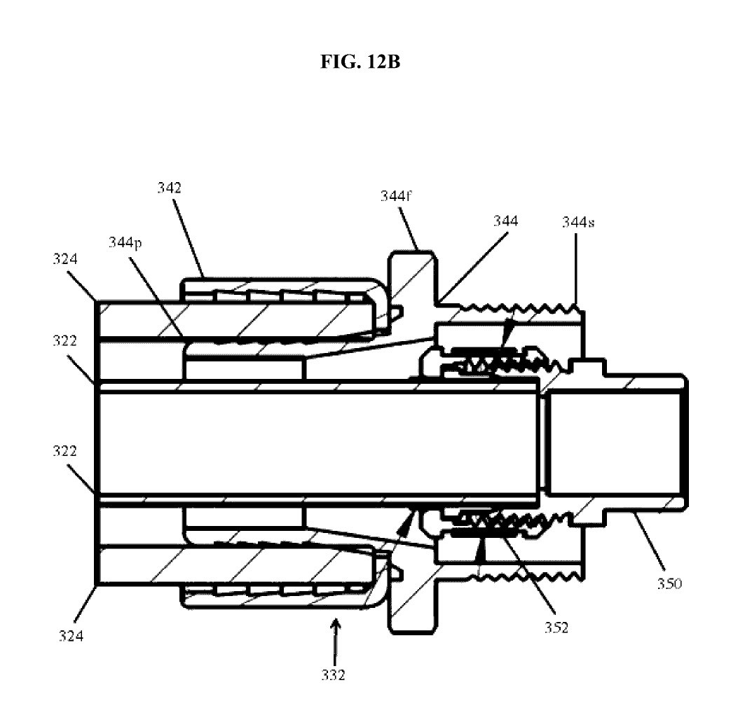

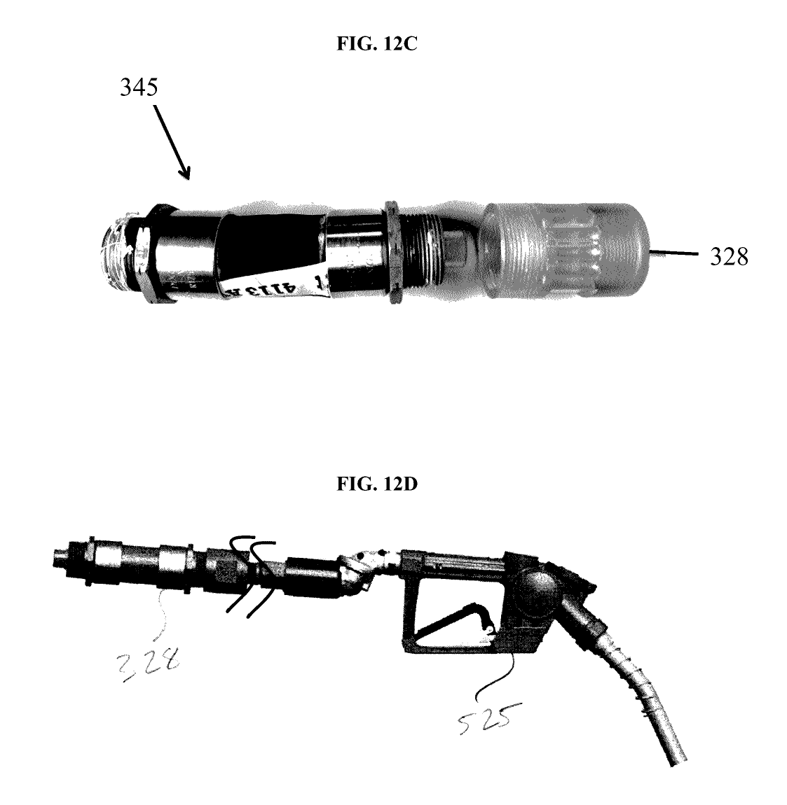

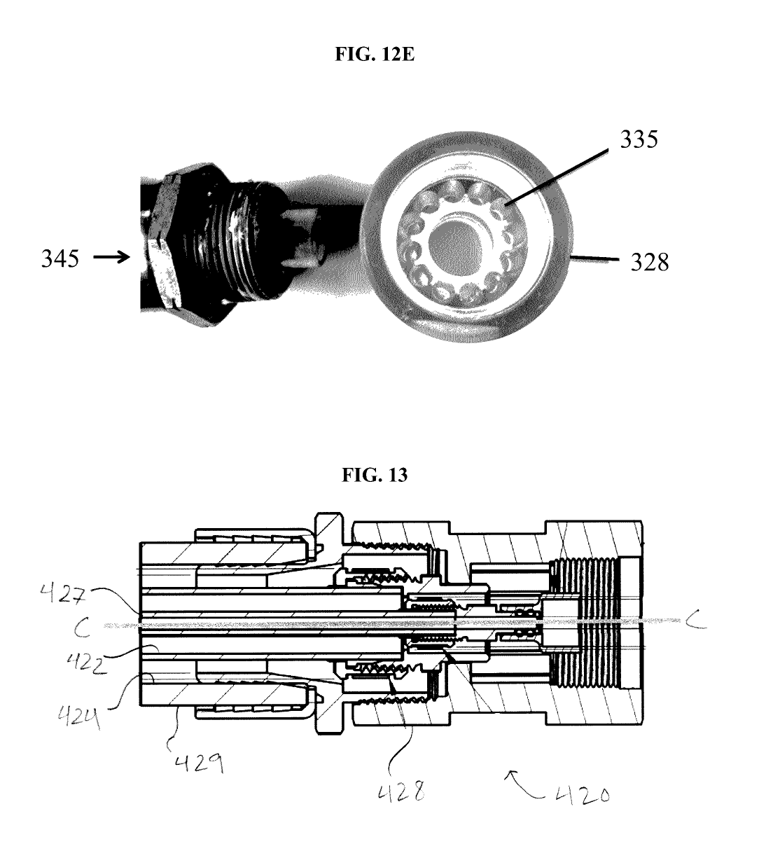

As indicated above, in certain embodiments the joint can include a coupling or manifold for connecting the upper and lower portions of the hose. FIG. 12A illustrates one exemplary embodiment of a portion of a fuel hose 320. The fuel hose 320 is similar to fuel hoses 20, 120, 220 and can be used to blend and deliver multiple fluids. An upper portion 329 of the fuel hose 320 has two separate tubular structures, an inner tubular structure 322 and an outer tubular structure 324. The tubular structures 322, 324 are positioned coaxially with respect to one another, rather than being positioned side-by-side and extending parallel. As such, the inner and outer tubular structures share a common longitudinal axis. The inner tubular structure 322 defines an inner fuel flow path F1 extending therethrough, and the outer tubular structure 324 defines an outer fuel flow path F2 extending therethrough and disposed around an exterior of the inner tubular structure 322. The tubular structures 322, 324 terminate in a coupling or manifold 328, and the fuel flow paths F1, F2 enter into and are blended within the coupling 328.

In an exemplary embodiment, the inner tubular structure 322 has a sidewall thickness that is less than a sidewall thickness of the outer tubular structure 324. The outer tubular structure generally is required to be relatively thick, as it is subjected to wear and tear during use. Typically, outer hoses are formed from a thick rubber to protect the fuel and internal components therein. Since the internal tubular structure is shielded and fully disposed within the outer tubular structure, the internal tubular structure need not be formed from rubber and need not have the same thickness. In certain aspects, the inner tubular structure can be formed from a nylon, which has a flexibility that is greater than the outer tubular structure. A person skilled in the art will appreciate that a variety of different materials and sizes can be used to provide an inner tubular structure that is lightweight, thin, and sufficiently flexible.

The coupling 328 can have a variety of configurations, but generally has two fluid flow paths in a first end that is coupled to the tubular structures 322, 324, and has a mixing chamber 330 where the first and second fluids are mixed to form a blended fluid. The blended fluid is delivered out of the second end of the coupling 328 along a fluid flow path F3 and is delivered to the lower portion of the hose for delivery to the nozzle.

In the illustrated embodiment, the coupling 328 generally includes two components, as shown disassembled in FIG. 12C. The first component 332, shown in FIG. 12A and shown separately in FIG. 12B, includes a first hollow cylindrical housing 342 that receives the terminal end of the outer tubular structure 324, and a second housing 344 that mates to the first housing 342. As shown, the outer tubular structure 324 extends into one end of the first housing 342. The second housing 344 has a tapered protrusion 344p that extends into the opposed end of the first housing 342, and into the terminal end of the outer tubular structure 324. As a result, the outer tubular structure 324 is crimped between the tapered protrusion 344p and the first housing 342. The tapered protrusion 344p defines a continuous fluid flow path F2 for fluid to enter the second housing 344 from the outer tubular structure 324. The second housing 344 also includes a central flange 344f formed at a mid-portion thereof that abuts the first housing 342 to act as a stop, and a threaded cylindrical protrusion 344s extending in a direction opposite to the tapered protrusion 344p and toward the nozzle. The threaded cylindrical protrusion 344s is configured to be received within the second component of the coupling 328, as discussed below.

As further shown in FIG. 12B, the terminal end of the inner tubular structure 322 extends through the outer tubular structure 324, and through the central lumen of the tapered protrusion 344p, the flange 344f, and the cylindrical threaded protrusion 344s. A stem 350 is disposed partially around a terminal end of the inner tubular structure 322, and a nut and clip 352 are disposed around the stem 350 and the inner tubular structure 322 to secure the stem 350 to the terminal end of the inner tubular structure 322. The stem 350 projects beyond the threaded cylindrical protrusion 344s for mating with the mixing chamber 330.

Referring back to FIG. 12A, the second component 334 of the coupling is in the form of a third hollow cylindrical housing having a first end with a threaded bore 334r formed therein for receiving and threadably mating with the threaded protrusion 344s on the second housing 344. The third housing 334 also includes a reduced diameter portion or inner flange 334d that defines a reduced diameter opening therethrough. The reduced diameter opening 334d is configured to receive the stem 350 coupled to the terminal end of the inner tubular structure 322. The third housing 334 also has a mixing chamber 330 formed therein on an opposite side of the inner flange 334d and the threaded bore 334r. The stem 350 will thus extend into the mixing chamber 330 so as to allow fluid flowing through the inner tubular structure 322 to be delivered to the mixing chamber 330. In order to allow fluid flow through the outer tubular structure 324 to be delivered to the mixing chamber 330, the inner flange 334d can include a plurality of ports or holes 335 formed therein around the perimeter thereof, as shown in FIG. 12E. Once fluid is mixed in the mixing chamber 330, it flows out of the second end of the third housing 334, which is coupled to the lower hose portion. As shown, the second end of the third housing 334 has a threaded bore 334b formed therein that receives a threaded pipe nipple 370 for coupling to the lower hose portion. FIG. 12D illustrates the coupling 328 of FIG. 12A connected to the lower hose portion, which in turn is coupled to a nozzle 525.

A vapor recovery system, such as a vapor recovery hose, can optionally be incorporated into the fuel hose with a coupling. As illustrated in FIG. 13, a fuel hose 420 is similar to the fuel hose 320 and has an upper portion 429 with two separate tubular structures, an inner tubular structure 422 and an outer tubular structure 424. The tubular structures 422, 424 are positioned coaxially with respect to one another and are connected to a coupling 428, which in turn is connected to a lower portion of the fuel hose (not shown) having a single tubular structure for delivering a blended fuel to a nozzle (not shown). As with the fuel hose 320, the inner and outer tubular structures 422, 424 have an inner fuel flow path and an outer fuel flow path that flow into the coupling 428. However, a vapor recovery hose 427 is incorporated into the fuel hose 420. The vapor recovery hose 427 extends through the fuel hose 420 along line C illustrated in FIG. 13, and is coaxially aligned with both the inner and outer tubular structures 422, 424. Several connection elements can be disposed within the stem of the second housing for facilitating passage of the vapor recovery line through the inner tubular structure without interfering with the delivery of fluid from the inner tubular structure into the mixing chamber and thereafter to the lower hose portion.

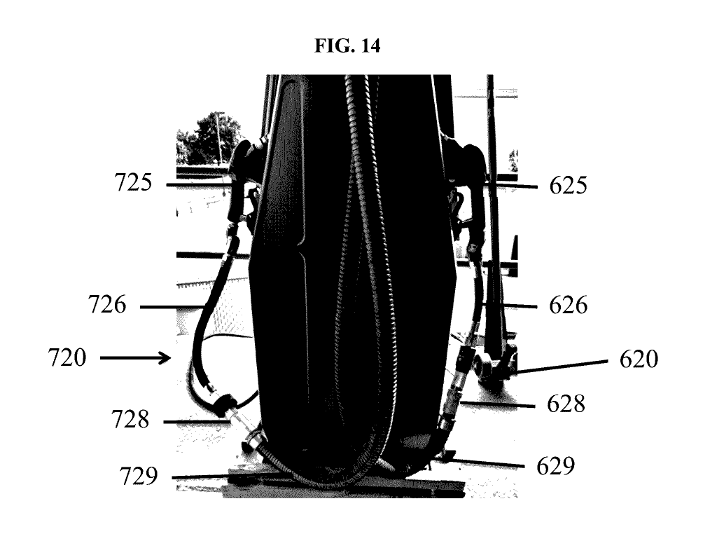

FIG. 14 illustrates two different embodiments of fuel hoses 620, 720 similar to the fuel hoses discussed above. Fuel hose 620 has an upper portion 629, a coupling 628, and a lower portion 626 with a nozzle 625 coupled thereto. Fuel hose 720 has an upper portion 729, a coupling 728, and a lower portion 726 with a nozzle 725 coupled thereto. Both of the upper portions 629, 729 incorporate at least two separate fuel pathways which are blended in the respective coupling 628, 728 and then delivered to the lower portions 626, 726. The lengths of the lower portions 626, 726 can be varied to make the fuel hoses 620, 720 more maneuverable while still providing adequate fluid flow. For example, a length of the lower portion 626 on the first hose 620 is less than a length of the lower portion 726 on the second hose 720. The lengths can be varied to prevent the couplings from colliding with a user and/or a vehicle when a user attempts to use the fuel hoses.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A fuel hose for blending and delivering multiple fuels, comprising:
an upper hose portion having first and second elongate hollow structures extending therethrough adjacent to one another, the first elongate hollow structure having a first end configured to receive a first fuel and a second end, and the second elongate hollow structure having a first end configured to receive a second fuel and a second end; and
a lower hose portion having a third elongate hollow structure with a first end that is coupled to both the second end of the first elongate hollow structure and the second end of the second elongate hollow structure such that the third elongate hollow structure is configured to receive a blended fuel formed from the first and second fuels, the lower hose portion having a second end that is configured to couple to a nozzle.

2. The fuel hose of claim 1, wherein the lower hose portion has a flexibility that is greater than a flexibility of the upper hose portion.

3. The fuel hose of claim 1, wherein the upper hose portion includes an outer retainer having the first and second elongate hollow structures disposed therein.

4. The fuel hose of claim 1, wherein the lower hose portion has a length that is less than a length of the upper hose portion.

5. The fuel hose of claim 1, wherein a diameter of the upper hose portion is equal to or greater than a diameter of the lower hose portion.

6. The fuel hose of claim 1, further comprising a vapor recovery hose extending through the upper and lower hose portions.

7. The fuel hose of claim 6, wherein the vapor recovery hose is sandwiched between the first and second elongate hollow structures in the upper hose portion.

8. The fuel hose of claim 1, wherein the first and second elongate hollow structures each have a substantially D-shaped cross-section.

9. A fuel hose for blending and delivering multiple fuels, comprising:
an upper hose portion having a first channel extending therethrough for delivering a first fuel, and a second channel extending therethrough for delivering a second fuel, the upper hose portion having a first end configured to couple to a fuel dispenser for receiving the first and second fuels, and a second end;
a lower hose portion having a third channel extending therethrough and having a first end and a second end configured to couple to a nozzle; and
a manifold having a first end coupled to the second end of the upper hose portion for receiving the first and second fuels from the first and second channels in the upper hose portion, and the manifold being configured to deliver the first and second fuels to a mixing chamber formed within the manifold such that the first and second fuels mix to form a blended fuel, and the manifold having a second end coupled to the first end of the lower hose portion for delivering the blended fuel to the lower hose portion.

10. The fuel hose of claim 9, wherein the manifold includes first and second separate and distinct fuel channels formed in a first portion thereof adjacent to the first end for receiving the first and second fuels from the second end of the upper portion, and the mixing chamber is formed in a second portion thereof adjacent to the second end for delivering the blended fuel to the lower hose portion.

11. The fuel hose of claim 9, wherein the lower hose portion has a flexibility that is greater than a flexibility of the upper hose portion.

12. The fuel hose of claim 9, wherein the lower hose portion has a length that is less than a length of the upper hose portion.

13. The fuel hose of claim 9, wherein the first and second channels in the upper hose portion extend adjacent to one another through the upper hose portion.

14. The fuel hose of claim 9, wherein the second channel is coaxially disposed within the first channel in the upper hose portion.

15. The fuel hose of claim 9, further comprising a vapor recovery hose extending through the upper hose portion, through the manifold, and through the lower hose portion.

16. The fuel hose of claim 15, wherein the vapor recovery hose extends through one of the first and second channels in the upper hose portion.

17. The fuel hose of claim 15, wherein the vapor recovery hose is sandwiched between the first and second channels in the upper hose portion.

18. A fuel dispenser, comprising:
a dispenser housing including at least one fuel pumping unit;
a hose having
an upper hose portion with a first end coupled to the dispenser housing, the upper hose portion having first and second fuel flow pathways, the first fuel flow pathway being configured to receive a first fuel from the at least one fuel pumping unit, and the second fuel flow pathway being configured to receive a second fuel from the at least one fuel pumping unit, and
a lower hose portion having a first end in fluid communication with a second end of the upper hose portion and being configured to receive a blended fuel formed from mixing of the first and second fuels from the first and second fuel flow pathways, the second hose portion having a second end coupled to a nozzle for delivering the blended fuel to a vehicle.

19. The fuel dispenser of claim 18, further comprising a coupling connected between the second end of the upper hose portion and the first end of the lower hose portion, the coupling including a blending chamber that forms the blended fuel by mixing the first and second fuels.

20. The fuel dispenser of claim 19, wherein, when the nozzle is seated within a nozzle boot on the dispenser housing, the coupling is positioned at a lower elevation than the upper and lower hose portions.

21. The fuel dispenser of claim 19, wherein the lower hose portion has a length that is less than a length of the upper hose portion.

22. The fuel dispenser of claim 19, wherein a diameter of the upper hose portion is equal to or greater than a diameter of the lower hose portion.

23. The fuel hose of claim 1, further comprising a vapor recovery hose extending through the upper and lower hose portions.
